(19) United States
(12) Patent Application Publication
(10) Pub. No.: US 2002/0046305 A1
(43) Pub. Date: Apr. 18, 2002

(54) Method for effective binary translation between different instruction sets using emulated supervisor flag and multiple page tables

(76) Inventors: Boris A. Babaian, Moscow (RU); Roman A. Khvatov, Khimky (RU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/838,550

(22) Filed: Apr. 18, 2001

Related U.S. Application Data
(63) Continuation-in-part of application No. 09/505,652, filed on Feb. 17, 2000.
(60) Provisional application No. 60/120,348, filed on Feb. 17, 1999.
(60) Provisional application No. 60/120,376, filed on Feb. 17, 1999.
(60) Provisional application No. 60/120,380, filed on Feb. 17, 1999.
(60) Provisional application No. 60/120,457, filed on Feb. 17, 1999.
(60) Provisional application No. 60/120,458, filed on Feb. 17, 1999.
(60) Provisional application No. 60/120,459, filed on Feb. 17, 1999.
(60) Provisional application No. 60/120,504, filed on Feb. 17, 1999.

(51) Int. Cl. G06F 3/00

(52) U.S. Cl. 710/5

(57) ABSTRACT

The present invention relates to a microprocessor based computer system having binary translation support to achieve high performance without compatibility problems. The computer system includes a support software layer that enables the execution of foreign application and operating system software without degradation during execution. The support software layer includes an emulated foreign supervisor flag and means for porting foreign software including the operating system to the host platform. The host platform includes host and foreign virtual space spaces and two page tables supported in hardware to minimize the time required for translation between virtual to physical addresses. A flag in a page table entry marks pages in the virtual memories having data that is accessible only to the host platform's supervisor. When the computer system processor is not operating in a foreign supervisor mode, an attempt to access the virtual space generates an exception trap.

### CLAIM OF PRIORITY

This Continuation-in-part application claims priority from co-pending U.S. patent application Ser. No. 09/505,652, filed Feb. 17, 2000, entitled “System for Improving Translation of Software from a Native Computer Platform to a Target Computer Platform,” which is a non-provisional of U.S. Provisional Patent Application Nos. 60/120,348, 60/120,376, 60/120,380, 60/120,457, 60/120,458, 60/120,459, and 60/120,504, all filed Feb. 17, 1999; each of which is incorporated by reference as if set forth in full in this document.

### CROSS-REFERENCES TO RELATED APPLICATIONS

This Continuation-in-part application is related to co-pending U.S. Patent Application No. _/_____ (Attorney Docket 20181-49), filed Apr. 18, 2001, entitled “Method and Apparatus for Preserving Precise Exceptions in Binary Translated Code;” U.S. Patent Application No. _/_____ (Attorney Docket 20181-50), filed Apr. 18, 2001, entitled “Method for Fast Execution of Translated Binary Code Utilizing Database Cache for Low-Level Code Correspondence;” and U.S. Patent Application No. _/_____ (Attorney Docket 20181-55), filed Apr. 18, 2001, entitled “Method for Emulating Hardware Features of a Foreign Architecture in a Host Operating System Environment” each of which is incorporated herein by reference as if set forth in full in this document.

### BACKGROUND OF THE INVENTION

There are a wide variety of commercially available microprocessors (often referred to as “processors”) that a system designer may select for a particular application. Many of these processors are based on different design philosophies such as reduced instruction set computing (RISC) versus complex instruction set computing (CISC) and on different length of an instruction word (32-bit versus 64-bit versus 128-bit). In addition to different design philosophies manifested by the instruction set, various other architectural differences may be found in various processors. For example, some processors may execute instructions in parallel while others do not. Other processors may use shared memory while others do not.

With the variety of commercially available processors based on competing and often incompatible architecture, a tremendous amount of application software developed for one type of microprocessor cannot execute on a computer system based on a different architecture. Typically, there are two processes for enabling the execution of foreign software on a host system based on a different architecture: porting and binary translation. Software porting requires the legacy source code to be translated to code that, when compiled, will execute on the host computer system. While it is possible to port foreign source code, it is a difficult task that requires a complete understanding of both the legacy architecture and the new host architecture. Further, there are times where the source code, the human readable version of the foreign software, is not available. Without the source code, it is nearly impossible to accurately port the software to the new host architecture.

Binary translation is the process of translating previously compiled software so that it will execute on the host architecture. Various binary translation techniques are known in the art. In general, binary translation converts binary foreign code, which is legacy software originally written and compiled for a specific architecture, to host code capable of being executed by a host computer system. More specifically, binary compilation is the process of detecting each instruction and converting these instructions to one or more equivalent host operations. Translation enables the execution of foreign software on computer systems other than the architecture for which it was originally compiled. Binary translation is often used to extend the life of the software past the life of the architecture for which the software was originally designed thereby increasing the commercial value of the software.

When a host computer system executes binary translated code, the foreign operating system code must also be translated. Thus, the host computer is tasked with performing the same operating system functions in a manner that achieves the same results that the foreign operating system executing on the foreign computer system would achieve. This requires that the host computer system be able to distinguish between foreign application code and data and foreign operating system code because application code is only authorized to modify data or code in certain areas of memory. The host computer must rapidly determine whether access to a memory location is permitted when executing binary translated code. This task is complicated by the inherent differences that arise due to the variety of different architectural designs. For example, computer systems based on the x86 architecture use paged-memory and a logical addressing scheme (x86 processors are commercially available from Intel Corporation and Applied Micro Devices, Inc.). In the x86 systems, logical memory addresses are transformed into physical addresses in two steps. The first step is segment translation, the process of converting a logical address to a linear address. After the linear address is obtained, it is converted to a physical address by specifying a page table, a page within that table and an offset within the page. Collectively, this information refers to a physical address. Once the physical address is determined, the appropriate page of memory must be moved to memory.

However, due to architectural differences, the host system may not allocate the page of memory to an identical physical address. Thus, the foreign memory scheme is not identically reproduced in the host environment thereby complicating the execution of binary translated code. Further, the host processor must determine whether a memory access request is permitted or not. Clearly, the efficiency with which the host processor can maintain correspondence of memory in the host environment will have a significant impact on the efficient execution of binary translated code. For example, when an application program attempts to access a memory location, the host computer system must quickly and efficiently validate memory access requests and move the requested pages of memory to system memory. Accordingly, what is needed is a method for quickly and efficiently validating memory access requests when executing binary translated code. More particularly, what is needed is a computer system that is capable of handling memory access requests when executing binary translated code in a manner that accounts for the different memory configurations in the foreign and host environments.

When the host computer translates the foreign operating system code along with foreign application code. The host computer is also tasked with performing the same functions just as if the foreign operating system were executing on the foreign computer system. However, porting an foreign operating system to a new platform is non-trivial. Indeed, significant degradation of performance often arises when an operating system is ported to an architecturally different environment. Accordingly, what is needed is a computer system adapted to implementing the functions of a foreign operating system when executing binary translated application code.

### SUMMARY OF THE INVENTION

The present invention relates to a microprocessor based computer system (or “platform”) that efficiently executes binary translated code. The computer system includes means for protecting translated host code, a novel support operating system that interfaces the foreign operating system to the hardware level of the computer system. The support operating system monitors a target supervisor flag to ensure access to memory is authorized. In accordance with the present invention, a binary translated operating system, written for a foreign architecture, is emulated by hardware mapping foreign and host virtual space under control of a support operating system in a host computer system. The support operating system implements the features and functions of the translated operating system on the host computer system.

In one preferred embodiment, the host computer system maintains foreign code and data in the foreign virtual space. Host code and translation processes are maintained in the host virtual space. Virtual spaces are linear logical memory spaces used by the host processor to store data and instructions (code). A memory management unit (MMU) maps the virtual spaces to physical memory to eliminate time consuming virtual to physical address translation. Without the MMU, emulation of virtual memory in response to a memory access by foreign code would have to pass through multiple levels of page tables posing a significant computational burden. Indeed, if attempted in software, the emulation would add an execution overhead equivalent of multiple commands for each and every memory access even if a software address cache were maintained. The system includes two page tables supported in hardware; and an access watch engine. The access watch engine detects write accesses to physical memory pages and notifies the support operating system of the memory access.

In operation, the host computer system monitors attempts to modify foreign memory. When a memory access occurs, locations in the foreign virtual space are translated to a host virtual space address in the host system memory. The translation process issues a trap if the corresponding memory address is not currently in physical memory. The trap handler allocates a portion of physical memory for at least a page of memory containing the requested address. Address translation hardware in the MMU is then adjusted to translate the original virtual address space to this physical page so that the memory access operation can complete. The host platform maintains two page tables supported in hardware. One page table assists in the translation of foreign virtual space to a physical address. The second page table assists in the translation of host virtual space to a physical address. Page tables are data structures that enable translation between a virtual space address and its corresponding physical memory address.

A flag in a page table entry marks pages in the virtual memories having data that is only accessible when operating in a host supervisor mode. When the host processor is not operating in the supervisor mode, an attempt to access protected virtual space generates an exception trap. The present invention uses software code protection technique to identify protected virtual space. More specifically, when the foreign operation switches mode of operation from supervisor mode to a user mode, some page of memory previously marked as supervisor access only become effectively inaccessible. This means that the corresponding translated binary code (generated by host processes by translating foreign code) must be invalidated and deleted from host virtual space. Unfortunately, invalidating the code means that the translation processes must be invoked when operation returns to supervisor mode and the invalidated code re-translated. This need to repetitively translate supervisor-only accessible code leads to inefficient operation. To improve efficiency, an emulated target supervisor flag is defined. This flag identifies all supervisor-only accessible code in host virtual space that corresponds to supervisor-only accessible code in foreign virtual space. Thus, any attempt to execute in host foreign space the supervisor-only accessible code while in the user mode of execution by the foreign CPU will issue a trap thereby eliminating the need to repetitively translate supervisor accessible code.

Other features and advantages of the invention will be apparent in view of the following detailed description and appended drawings.

### BRIEF DESCRIPTION OF THE DRAWINGS

FIG. 1 illustrates a representative embodiment of a host computer system;

FIG. 2 illustrates a representation of a foreign and a host virtual memory in the host computer system illustrated in FIG. 1;

FIG. 3 is a more detailed illustration of the configuration of the foreign and host virtual memory in the host computer system.

FIG. 4 illustrates an n-level page table structure for determining the physical address in the host computer system.

### DESCRIPTION OF SPECIFIC EMBODIMENTS

The present invention relates to an apparatus and method for executing foreign binary code on a host computer. More particularly, the present invention relates to an improved apparatus and method for efficiently executing foreign code on a host system in real time. In the following description of preferred embodiments, reference is made to the accompanying drawings that form a part hereof, and in which is shown by way of illustration a specific embodiment in which the invention may be practiced. It is to be understood that other embodiments may be utilized and that changes may be made without departing from the scope of the present invention. For purposes of illustration, the following description describes the present invention as used with computer systems based, in general, on a RISC-based processor. However, it is contemplated that the present invention can also be used as a part of computer systems having multiple such processors or having CISC-based processors. It will also be apparent to one skilled in the art that the present invention may be practiced without the specific details disclosed herein. In other instances, well-known structures and techniques associated with the described processor or computer system have not been shown or discussed in detail to avoid unnecessarily obscuring the present invention. Reference will now be made in detail to the preferred embodiments of the invention, examples of which are illustrated in the accompanying drawings. Wherever possible, the same reference numbers will be used throughout in the drawings to refer to the same or like components.

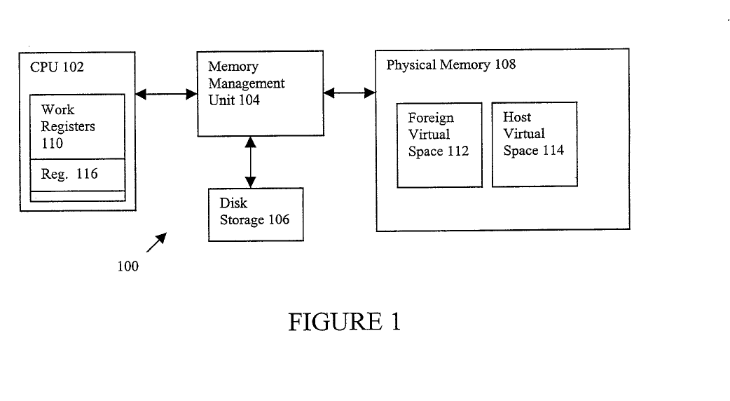

Referring now to FIG. 1, a host computer system 100 is illustrated. Host computer system 100 comprises a central processing unit (CPU) 102, a memory management unit (MMU) 104 and a storage device such as disk drive 106 coupled together by communication buses. MMU 104 is further coupled to physical memory 108 that preferably comprises both random access memory (RAM) and non-volatile memory. Host CPU 102, which in one preferred embodiment is the E2k microprocessor designed by Elbrus International, the assignee of the present invention, manages the process of translating foreign code into host code and executing the host code. Host CPU 102 includes a set of work registers 110 that can be dynamically renamed so that both a foreign and a host register set can be maintained during execution of foreign code.

MMU 104 includes logic to form and maintain a foreign virtual space 112 and a host virtual space 114 in physical system memory 108. MMU 104 includes a translation lookaside buffer (TLB) to manage coherence between foreign code in foreign virtual space 112 and translated binary code in host virtual space 114. MMU 104 also implements a conventional demand-page virtual memory system for each executing task. The TLB maintains the most recently accessed page-directory and page-table entries in a cache to minimize the number of bus cycles to recover a requested page for both the foreign virtual memory 108 and host virtual memory 114. Requests for access to virtual space are handled by TLB so that disk access is necessary only when the requested page descriptor (either a page-directory or a page-table entry) is not in the TLB cache.

In accordance with the present invention, host computer system 100 translates foreign binary code to host code at run-time. As used herein, foreign code means computer instructions written for a foreign processing system. More specifically, foreign code refers to operating system and application code intended for execution on the foreign architecture. The foreign architecture may, by way of example, be a computer processing system based on an Intel x86 processor, a Motorola 68xxx processor or a Sun Sparc processor. Compounding the difficulties of executing binary translated foreign code on the host is the architectural difference between the host computer system 100 and the foreign system. Regardless of the foreign architecture, foreign code and data are transferred to foreign virtual space 112 while corresponding translated host code is stored in host virtual memory 114.

Host computer system 100 translates foreign binary code to equivalent host code (referred to as translated binary code) to reproduce the behavior of the foreign code on the foreign architecture. To minimize performance penalties associated with executing translated binary code, host CPU 102 maintains the same data representation and processing logic as in the foreign architecture. A portion of work registers 110 is allocated for use as foreign registers and a portion for use as host registers. Host computer system 100 has certain foreign architecture independent features and some platform specific features to minimize performance degradation. Foreign hardware features that do not influence performance are preferably implemented in software.

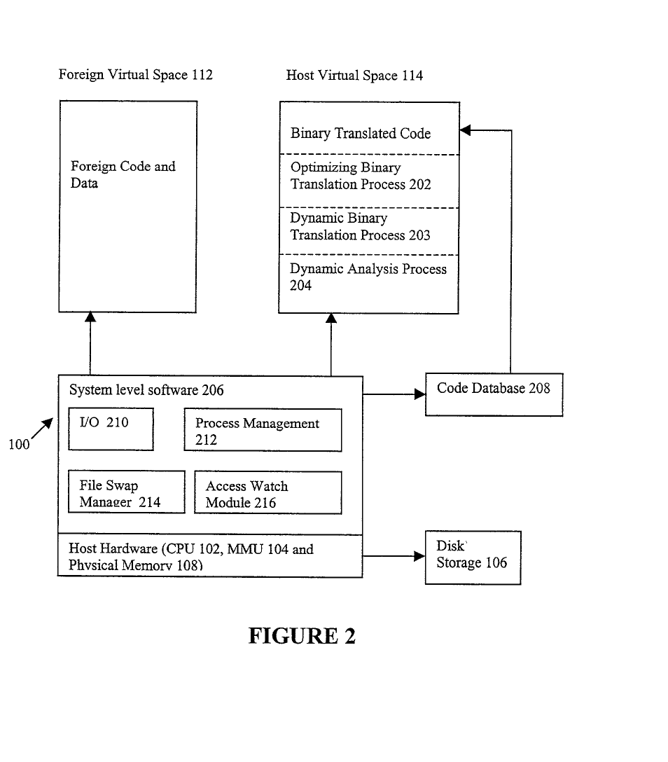

Referring now to FIG. 2, a more detailed illustration of computer system 100 is shown. Computer system 100 comprises a hardware layer that includes the host CPU 102, MMU 104 and physical memory 108 together with additional hardware support for efficient and reliable execution of translated binary code. Computer system 100 further includes a system level software layer 206 that is responsible for interfacing the hardware level to the virtual spaces 112 and 114. Software layer 206 functions as a minimal operating system for host computer system 100 when executing binary translated foreign code. Software layer 206 further controls the process of decoding and semantic substitution using binary translator software resident in host virtual space 114. The primary function of software layer 206 is to interface the binary translation process with hardware-specific features of the host platform. To minimize the size of software layer 206, many features, which are inherent to a typical operating system, are omitted in the preferred embodiment. For example, software layer 206 does not include support for a file system, process management or virtual memory management. Software layer 206 includes limited support for a file system, process management and virtual memory management. The file system is only used by software layer 206 and to manage a small startup database. The process manager does not include a process scheduler as this function is obtained from the foreign operating system. The virtual memory manager is restricted to support native applications such as the binary compiler.

Software layer 206 is tasked with servicing hardware and software exceptions specific to the host system and interfacing to the system hardware. Software layer 206 functions in conjunction with hardware support features to achieve correct execution of binary translated foreign code. To improve execution time, software layer 206 includes several dedicated modules directed to performing specific tasks. I/O module 210, when invoked by software layer 206, detects input or output operations by external devices that modify memory. The I/O devices may be either real or emulated. I/O module 210 also manages all access to disk drive system 106. Software layer 206 provides process management support by creating and terminating processes such as the binary translation processes 202-204 with process management module 212. This support includes allocation and management of resources for each executing process. With file swap module 214, software layer 206 manages file swaps in the host virtual space and database support. Although software layer 206 does not include a task or file manager, the software layer 206 responds to foreign operating system attempts to switch tasks or update file structure on disk drive system 106. To manage memory access, software layer 206 also includes an access watch module 216 that is responsible for monitoring changes to the foreign virtual memory space, including DMA device access. Software layer 206 provides virtual space support of foreign space by performing the page format translation from foreign to native and then watches for foreign page table modifications. Software layer 206 also maintains a database of active virtual machines as well as the creation and destruction of virtual machines.

Computer system 100 includes selected hardware components such as graphics adapters, printers, communication ports, tertiary storage devices such as additional disk drives and CD-ROM drives (not shown). Since it is possible to intercept functional requests and map the function to a corresponding device, computer system 100 may translate the function requested by the code in foreign virtual space to a corresponding device that provides the equivalent function. Of course, the hardware specifications associated with the device requested by the foreign code must be known in advance and assigned to a corresponding device. Further, many of these devices will also be used by the host system in addition to the foreign applications. Accordingly, software layer 206 also arbitrates access to these hardware components. For example, software layer 206 accesses disk drive 106 for storage of code and data and for maintaining a binary compiled database of code segments that have a high frequency of use. If specifications for a particular hardware device are not known, software layer 206 merely bypasses access requests to the hardware device. The operational specifications for the hardware devices are typically provided to software layer 206 in the form of a dynamically loadable hardware emulator module. Software layer 206 dispatches internal, external and foreign traps so if unsupported hardware device is capable of modifying memory, a trap is generated with instructions to acquire the specifications for the hardware device.

In order for computer system 100 to execute foreign code, the code is first transferred from disk drive 106 and maintained in foreign virtual space 116. Host processes used by computer system 100 to translate the foreign code are maintained in host virtual space 114. These processes include a dynamic binary translation process 203 and a dynamic analysis process 204. Dynamic binary translator 203 is used as a fast interpreter of a foreign code for two purposes. First, it enables immediate execution of the foreign code even if there is no pre-existing translated binary code in database 208 and to prepare information for the optimizing binary translator. Second, dynamic binary translator 203 is used in any recovery process for precise interrupt maintenance.

Dynamic analysis process 204 functions like a monitor in the binary translation system. Dynamic analysis process 204 helps not only to control execution of translated binary code, but also to process all exceptions properly, and to invoke optimizing binary translator and provide it with profile information. Dynamic analysis process 204 also includes memory management functions relating to maintaining translated binary code compaction in memory and support coherence with the foreign code. Dynamic analysis process 204 is also responsible for processing special situations during execution of the translated binary code that were not discovered during binary translation. For example, self-modifying code, newly created code and exceptions are all situations that may not be discovered at binary translation time.

All new information collected by the dynamic analysis process 204 is saved for further utilization by the optimizing binary translation process 202. Dynamic binary translation process 203 and optimizing binary translation process 202 execute simultaneously. As binary translator process 202 translates foreign code in optimized mode, dynamic binary translator 203 translates the code in fast and simple mode. When optimized translated binary code is ready, the control switches over to the optimized code at a coherent point for execution.

Typically, an entire sector of the code is transferred from disk drive 106 to memory 108 in a single operation. During the transfer process, computer system 100 uses low-level code correspondence checking during the runtime binary translation process where a sequence of low-level code is a sequence of basic machine operations. Each sequence is translated using optimizing binary translation process 202, dynamic binary translation process 203 and dynamic analysis process 204 in order to obtain optimal performance on host computer system 100. Where there is constant swapping of code in foreign virtual space 112, performance can degrade while processes 202-204 translate the code. Further, in some instances, processes 202-204 could be repetitively translating a limited number of code segments resulting in an inefficient utilization of host computer 100 resources.

To improve performance, code database 208 functions in conjunction with software 206 to minimize the necessity to translate code each time a swap occurs. As each sequence of binary operations is transferred to memory 112, corresponding translated code is transferred to host memory 114 for execution by the host computer 102 while bypassing processes 202-204. Thus, rather than translating the sequence each and every time foreign code is swapped into foreign virtual space 116, the corresponding host code stored in code database 208 is accessed on an as-needed basis and moved directly to active system memory of the host computer. With the corresponding host code in memory, processes 202-204 need not perform their translation functions thereby improving the utilization of system resources. If the database 208 does not contain corresponding code, then the method of the present invention provides for generating translated binary code by invoking processes 202-204. As soon as the binary host code is present in memory 108, execution units 106 may execute the code.

After executing the binary translation process, the binary translated image (that is, host code) of the foreign code is available for execution by the host processor. All foreign data remains in the foreign virtual space because there could be constants in the original foreign code that the translated host code might have read. Rather than analyze the foreign code to find all memory accesses and then transfer data and constants to the host virtual memory, the binary translation processes maintains the data and constants in the foreign virtual space. Thus, as the translated binary code in host virtual memory space executes, the behavior of the foreign virtual space looks as if it is being updated in real-time just as if it were executing on the foreign platform. Accordingly, the host code must be able to access the portion of physical memory containing the foreign code, data and constants.

After binary translation of the foreign code, the binary translated code in foreign virtual space is write-protected so any subsequent write accesses will cause an exception. This protection mechanism maintains coherence between the foreign code and the translated binary code. When a valid write occurs, the page is updated and a determination must be made as to whether the binary translated host code is thereby invalidated.

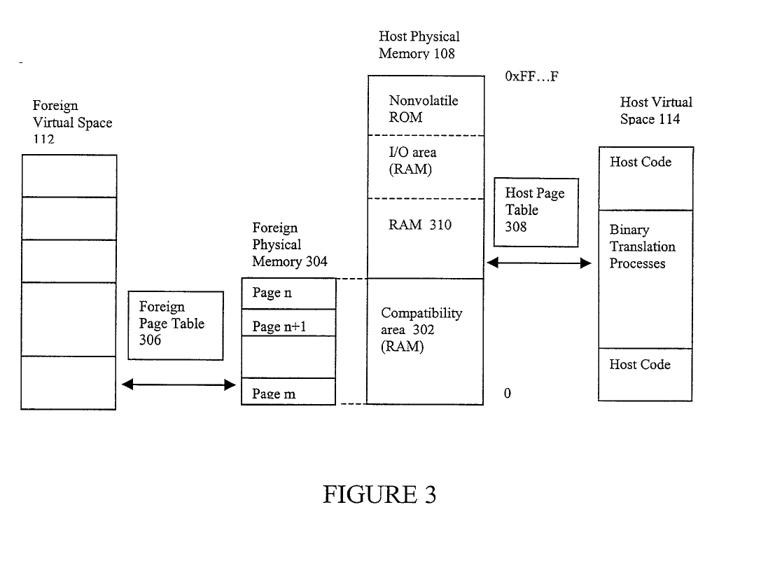

Referring now to FIG. 3, a representative memory map of computer system 100 is illustrated. Physical memory 108 includes a compatibility area 302 of RAM in low memory. Compatibility area 302 maps to the available host system memory allocated as foreign physical memory 304. Typically, the amount of foreign physical memory 304 will be less than the amount of physical memory available in the foreign platform. Accordingly, a foreign page table 306 maps foreign virtual space 112 to compatibility area 302. It is to be understood that a foreign page table (not shown) is responsible for mapping the foreign logical/linear addresses to the foreign virtual space 112. Foreign page table 306 in essence supersedes the function of the page table associated with the foreign platform to perform the mapping to compatibility area 302. Thus, where foreign virtual memory 112 includes multiple executing tasks with each task having multiple pages, page table 306 is responsible for partitioning and paging in the appropriate code for execution by host CPU 102.

A second page table, host page table 308, similarly maps a portion of host physical memory 108 to host virtual space 114. Host page table 308 maps executing processes from host virtual space 114 into a region of RAM 310 of host physical memory 108. Host page table 308 also maps I/O devices into a region of RAM in an I/O area 312.

MMU 104 manages access to both foreign and host page tables 306 and 308. Using the foreign page table, MMU 104 maintains the structure of foreign virtual memory 112 as if it were maintained by a foreign platform. This control is ostensibly under control of the foreign operating system but changes are enacted only through the support software layer 306 by host code. Similarly, the host page table is only accessed by host code through the support software layer 306.

Maintaining the foreign architecture in virtual memory requires MMU 104 to manage the foreign memory as if under control of the foreign processor. Thus, if the foreign memory supports segmentation and paging, host computer system must be able to manage the memory space in accordance therewith. By way of example, if the foreign architecture is the x86 architecture, up to 64 Gbytes (236 bytes) of physical memory could be available to the foreign processor. This memory may be mapped to read-write memory, read-only memory and memory mapped I/O. Further, the foreign physical memory is divided into a plurality of segments and/or pages with each byte in the physical memory addressed by a logical address.

Computer system 100 must emulate the paging and segmentation of memory when foreign application code and data and foreign operating system code are transferred to foreign virtual space 112. However, computer system 100 need not necessarily allocate an address space comparable to the physical memory made available in the foreign system. Rather than allocating large amounts of physical memory for the foreign code, the host architecture maps the logical and linear address space paging of the foreign system into the physical memory in compatibility area 302. The MMU 104 handles this mapping function in hardware so that host computer system 100 need not incur an execution penalty for each access to native virtual space. This translation process issues a trap if the target page of memory has been previously swapped from host physical memory to external storage. The trap handler allocates a portion of physical memory and transfers the requested page of memory from external storage back into physical memory. The trap handler then adjusts the translation process in order to translate the original virtual memory address to the physical page and the memory access operation restarted. In the preferred embodiment, there is no swapping in foreign virtual space so any trap not expected by Access Watch module is directed to the foreign operating system.

To maintain the efficiency when executing binary translated code, support hardware in computer system 100 includes a dedicated register 116 in register set 110. Register 116 is used by access watch module 216 to monitor changes to memory. Register 116 points to a bit string maintained in host physical memory. The bit string is hidden from the foreign operating system code so as not to violate the contents of the foreign memory.

The bit string allocates two bits for each page of foreign memory and these bits are used to track code modification and to maintain correspondence between foreign and binary translated host code. One bit in the bit string applies access restriction to physical memory pages under control of support operating system 206. More specifically, this bit denotes if the associated page in foreign space 112 is a read-only page. The second bit denotes whether access to the page is permitted to the user or application programs. Together, these bits are accessed whenever a memory access in compatibility area 302 is requested. If access is denied, computer system 100 will trap any attempt to access a protected memory location.

If a first bit corresponding to a selected page is set, the corresponding physical memory is locked and any write access request will be denied. An attempt to modify a locked memory location generates a hardware exception. Attempts may occur if a new page of foreign code is being moved into memory or if data is being updated. The access watch module 216 detects the exception and determines if host virtual space needs to be updated with new host code. When modification to code in a particular page is detected, new host code may be transferred to host virtual space 114 to maintain correspondence between foreign and binary translated code. When code update occurs, the translation processes 202-204 are invoked.

The second bit in the bit string corresponding to each page identifies pages in host virtual space 114 for which access to the page is denied. This bit serves as an access lock flag effectively prohibiting access to the page. Thus, if foreign code attempts to access locked memory space, the attempted access will generate a trap. Using the bit string pointed to by register 116, access watch module 216 effectively controls modification of host and foreign virtual space, maintains consistency of host virtual space with foreign virtual space, manages host code execution, emulates hardware absent on host machine, and manages access to existing hardware.

If access watch module 216 denies access, a protection fault generated. In response access watch module 216 first checks the page ranges in the respective page tables to determine if the requested page is in physical memory. If the fault occurs within a valid range, and access is allowed, the fault is converted to a signal by access watch module 216. In this manner, binary translated code is invalidated (that is, deleted).

When the foreign operation switches mode of operation from supervisor mode to a user mode, some page of memory previously marked as supervisor access only become effectively inaccessible. This means that the corresponding translated binary code (generated by host processes by translating foreign code) must be invalidated. Unfortunately, invalidating the code means that the translation processes must be invoked when operation returns to supervisor mode and invalidated code re-translated. This need to repetitively translate supervisor-only accessible code leads to inefficient operation. To improve efficiency, an emulated target supervisor flag is defined. This flag identifies all supervisor-only accessible code in host virtual space that corresponds to supervisor-only accessible code in foreign virtual space. Thus, any attempt to execute in host foreign space the supervisor-only accessible code while in the user mode of execution by the foreign CPU will issue a trap.

When an external device attempts to access a memory location, access watch module 216 intercepts the request and routes it to a handler. Using this methodology, computer system watches for input or output operations by foreign peripherals not present in the host environment. When a non-existent peripheral is detected, the support operating system emulates the peripheral device, generates an exception or ignores the request. Access watch monitor 216 arbitrates between shared device access when distinct devices are mapped to a common physical location.

In accordance with the present invention, efficient emulation of a foreign architecture is accomplished through hardware mapping of foreign and host virtual space under control of support software 206. MMU 104 maps the virtual spaces to physical memory in hardware to eliminate time consuming virtual to physical address translation when executing binary compiled host code. In the absence of hardware mapping, the emulation of virtual memory in response to a memory access by the foreign code would have to pass through multiple levels of page tables posing a significant computational burden. Indeed, if attempted in software, the emulation would add an execution overhead equivalent of up to five commands for each and every memory access even if a software address cache were used.

When the foreign platform uses a page table structure to map foreign virtual memory space it is retained in foreign memory. Any modification in the original page table is reflected in the page table for foreign virtual space. Memory modification is detected by access-watch system and passed to the software module responsible for translation of the page tables.

Referring again to FIG. 3, host computer system 100 maintains in foreign virtual space an image of a foreign page table structure as maintained by the foreign architecture. The page table image is used in many prior art architectures to map a linear address space into a large physical memory or paged into a smaller physical memory. When execution requires access to a linear address not in physical memory, the page table image maps the linear address to a memory page in the foreign architecture. If the memory page is not currently in memory, a page-fault exception is generated directing the processor to load the correct page from disk storage into physical memory. Paging is a well-known process that permits a data structure (that is, either code or data) to be partially stored in physical memory and partially in disk storage.

In addition to the foreign page table, host computer system 100 maintains two page tables in hardware registers. Page table 306 defines the foreign virtual space 112 and page table 308 defines the host virtual space 114. Page table 306 emulates the architecture of foreign virtual space while page table 308 maps the host virtual space. Because the hardware emulation of foreign virtual space may use a page table structure that differs from the foreign page table, the MMU accesses the page tables when translating foreign and host virtual memory into physical memory.

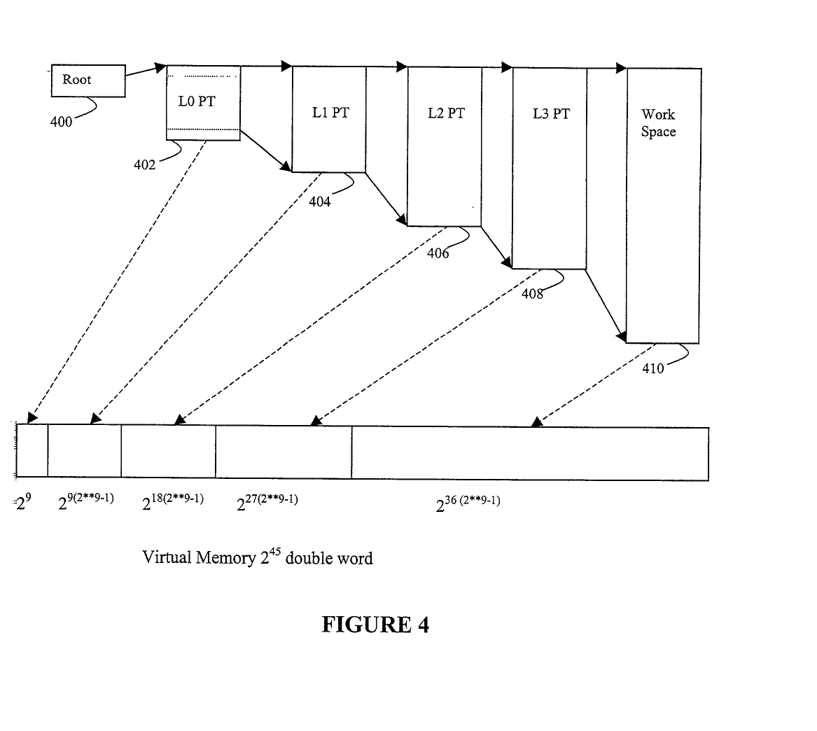

FIG. 4 illustrates one embodiment of a page table structure for determining the physical address in the host computer system. In one embodiment, an n-level page table structure is provided. Page table root structure 400 contains the root address of the top-level page table 402. Top-level page table 402 contains a plurality of entries that each define an entry point into the next level (level-1) page table 404. Likewise, page table 404 contains a plurality of entries that define the entries into a level-2 page table 406. Page table 406 provides the entries into level-3 page table 408. Page table 408 provides the entry into the virtual memory comprising workspace 410. Duplicate page table structures are maintained for both the foreign and host virtual spaces. Using this page structure, each virtual memory can include up to 245 double words of memory.

When executing code, the image of foreign code in foreign virtual space 112 is transferred to host virtual space 114 by binary translation processes 303-305 in the form of executable translated host code. The translated host code that corresponds to the foreign operating system is responsible for managing the structure of foreign virtual space 112 in foreign space while the structure of the host virtual space is managed by the support operating system 306.

Because host code accesses memory in both the foreign and host virtual space spaces, maintaining correspondence is a complicated task. Specifically, whenever there is a change to data or new code laid into foreign virtual space, host memory must also be updated. An access-watch system ensures that the foreign code is protected from inadvertent writes or modification by host code. When access-watch system detects a write to foreign virtual space corresponding to foreign code (as opposed to data), the write access invalidates the corresponding host code in host virtual space.

In order to control host virtual memory space, MMU 104 first sets up foreign virtual space and then initiates execution of corresponding host code by invoking the binary translation processes. If the foreign code expects to find hardware elements not present in host computer system, MMU 104 together with support operating system loads a dynamic link library module for emulating the absent hardware on host computer system. Support operating system 306 manages access to existing hardware so that access to a hardware device made from code is passed through binary translation processes during which the memory access for a hardware device is separated from an ordinary memory access. The binary translation process determines when a memory access is a hardware request by recognizing a class of commands as an I/O request or by designating a selected range of memory mapped to I/O devices. When a valid hardware access is detected, control is passed by support operating system 306 to a support module. The support module then passes the access request to the actual hardware device (such as, by way of example, the video system) or directs it to an emulator to emulate the hardware function.

In operation, the access watch module 216 performs an address range check upon a change to foreign virtual memory. In order to perform the check, the virtual addresses supplied to the access watch module are converted to physical addresses using information in host page table 308. Access watch module 216 then splits the supplied address range by page bounds. For all pages in supplied address range, access watch module sets the additional access restriction in accordance with the corresponding bit pair in the string of bits. Then, the original address range is added to a watch list of memory ranges.

When a page fault is detected, the access watch module checks the watch list and determines if the access is allowed by the access restriction as determined by the corresponding bits in the bit string. If the respective bits are set, it indicates that the memory access attempts to the page are read-only or more specifically, the memory is locked. If access is disallowed, then a foreign CPU exception is generated. If access is allowed, then the address is checked against all of the watched address ranges. If the address is within the range of the watch list, the access watch module generates a message to the task that created the watch list ranges.

Using the message, the memory access is then completed, the host and foreign virtual spaces are updated and the page tables revised, if necessary. If, however, the memory is not resident in host virtual space, a page fault is generated by MMU 104 and passed back to the access watch module. Any change to memory triggers the access-watch system. Although the memory change will vary depending on the circumstances, typically, the result of a memory change is to invalidate the binary compiled code in host virtual space. Once invalidated, the host code in memory is replaced by new binary translated code.

As an example, access-watch module detects write accesses to physical memory regardless of whether the access is initiated by the translated operating system code, an application program or an external hardware device. The access-watch module monitors the set of access flags associated with each page table and sets access rights to each page in memory. The flags are maintained in a bit string that may be placed in a separate space in memory separate from the page table, but logically the bit string is a continuation of the page table. Any access that causes a protection fault is signaled to support operating system by access-watch module so that the fault can be checked against access-watch ranges. If the protection fault occurs in access-watch range, and the original device requesting access is allowed access, then the protection fault is converted to an access-watch signal. The access-watch signal essentially invalidates the translated host code in the access-watch range. The range is then provided to the binary translation processes and the host virtual space is updated.

While certain exemplary preferred embodiments have been described and shown in the accompanying drawings, it is to be understood that such embodiments are merely illustrative of and not restrictive on the broad invention. Further, it is to be understood that this invention shall not be limited to the specific construction and arrangements shown and described since various modifications or changes may occur to those of ordinary skill in the art without departing from the spirit and scope of the invention as claimed.

What is claimed is:

1. A system for translating foreign binary code for execution on a host computer system where the host computer system is architecturally distinct from the foreign architecture, said host computer system providing a foreign and a host virtual space, said computer system further comprising:
a first page table representative of the logical allocation of physical memory associated with said foreign binary code;
a second page table representative of the logical allocation of physical memory associated with binary translated code; and
means for maintaining said first and second page tables in response to changes generated by executing said binary translated code.

2. The system of claim 1 wherein said maintaining means further comprises a register dedicated to track code modification to maintain correspondence between foreign and binary translated host code flag, associated with each page of memory, to indicate modification of said page of memory.

3. The system of claim 1 further comprising a flag, associated with each page of memory, to indicate a change in a page in foreign virtual space.

4. The system of claim 1 further comprising means for restricting access to a page of memory in foreign virtual space.

5. The system of claim 4 wherein said restricting means comprises means for generating a trap.

6. The system of claim 1 wherein said first page table maps foreign code to a portion of physical memory.

7. The system of claim 6 wherein said first page table includes a first and second bit associated with each page of memory in foreign virtual space, said first bit indicating whether a page of memory in foreign virtual space is write protected and said second bit indicating a locked page of memory

8. The system of claim 7 further comprising means for determining the state of said first bit and invoking a page fault exception upon a change in page contents.

9. The system of claim 1 wherein said first page table includes a first and second bit associated with each page of host memory, said first bit indicating whether access to said page is restricted; said second bit indicated whether access to said page in said foreign virtual space is accessible only in a supervisor mode of operation.

10. A method for translating foreign binary code for execution on a host computer system where the host computer system is architecturally distinct from the foreign architecture, said host computer system providing a foreign and a host virtual space, said method comprising the steps of:
configuring a first and second virtual space;
storing foreign code in said first virtual space;
storing a plurality of translation processes in said second virtual space;
storing binary translated code in said second virtual space, said binary translated code comprising at least a portion of said foreign code in said first virtual space;
executing said binary translated code;
detecting a memory access that attempts to modify a memory location;
determining the status of the accessed memory location;
if the status permits access, modifying the memory location;
if the status does not permit access, generating a page fault exception.

11. The method of claim 10 further comprising the step of:
if the status indicates access is limited to code executing in an emulated target supervisor mode, determining if the computer system is executing in an emulated target supervisor mode; and
if the status indicates that the code is not executing in said emulated target supervisor mode, generating an exception.

12. The method of claim 11 further comprising the steps
if access is allowed, checking the address against a range of addresses; and
determining if the memory location to be accessed is currently in memory.

13. A method for translating foreign binary code for execution on a host computer system where the host computer system is architecturally distinct from the foreign architecture, said host computer system providing a foreign and a host virtual space, said method comprising the steps of:
configuring a first and second virtual space;
storing foreign code and data in said first virtual space;
storing binary translated code in said second virtual space, said binary translated code comprising at least a portion of said foreign code in said first virtual space;
defining a first page table to map said foreign code from said first virtual space to physical memory;
defining a second page table to map said binary translated code to said second virtual space;
associating information relating to said foreign code with said page table, said information determining if a portion of said foreign code and data in said virtual space may be accessed.

14. The method of claim 13 further comprising the step of using said information to determine if said foreign code comprises operating foreign system code.

15. The method of claim 14 further comprising the step of using said information to detect modification of said code and data in said foreign virtual space.

16. The method of claim 15 further comprising the step of invoking a binary translation process upon detection of modification of said code and data in said foreign virtual space to generate binary translated code corresponding to said code and data in said foreign virtual space.

17. The method of claim 13 further comprising the step of using said first page table to map a logical address of said foreign code to a compatibility region of physical memory in said host computer system.

18. A method for translating foreign binary code for execution on a host computer system where the host computer system is architecturally distinct from the foreign architecture, said host computer system providing a foreign and a host virtual space, said method comprising the steps of:
configuring a first and second virtual space;
storing foreign code and data in said first virtual space;
storing binary translated code in said second virtual space, said binary translated code comprising at least a portion of said foreign code in said first virtual space;
defining a first page table to map said foreign code from said first virtual space to physical memory;
defining a second page table to map said binary translated code to said second virtual space;
providing a support software layer, said software layer functioning as an operating system for controlling the binary translation of said foreign code and data and for detecting a write access to physical memory of said host computer system, said physical memory corresponding to said foreign virtual space by said host code.

19. The method of claim 18 further comprising the step of executing said support software layer in said second virtual memory, said support software layer adapted to managing I/O operations.

20. The method of claim 19, further comprising the step of virtualizing a restricted set of functions.

21. The system of claim 20, further comprising the step of virtualizing peripheral components expected in a target operating system.

22. A system for translating foreign binary code for execution on a host computer system where the host computer system is architecturally distinct from the foreign architecture, said host computer system providing a foreign and a host virtual space, said computer system further comprising:
a first page table representative of the logical allocation of physical memory associated with said foreign binary code;
a second page table representative of the logical allocation of physical memory associated with binary translated code; and
a support software layer adapted to maintain correspondence between foreign code and data in said foreign virtual space and a set of host instructions in said host virtual space.

23. The system of claim 22 wherein said support software layer comprises means for performing binary translation of said foreign code and said host code.

24. The system of claim 23 further comprising an access watch engine adapted to detect a write access to physical memory in said host computer system.

25. The system of claim 22 further comprising means for detecting write accesses to physical memory corresponding to said foreign virtual space.

26. The system of claim 25 further comprising means for detecting write accesses to physical memory corresponding to memory mapped peripherals.

27. The system of claim 25 further comprising means for virtualizing a restricted set of available hardware to produce enough resources to run resource-consuming firmware.

28. A system for translating foreign binary code for execution on a host computer system where the host computer system is architecturally distinct from the foreign architecture, said host computer system providing a foreign and a host virtual space, said computer system further comprising:
a physical memory;
a first page table representative of the logical allocation of physical memory associated with said foreign binary code;
a second page table representative of the logical allocation of physical memory associated with binary translated code;
a support software layer adapted to maintain correspondence between foreign code and data in said foreign virtual space and a set of host instructions in said host virtual space; and
an emulated supervisor flag associated with portions of said host binary code where said support software layer accesses said supervisor flag prior to executing a write access into said foreign and host virtual spaces.

29. The system of claim 28 further comprising means for detecting said supervisor flag and marking selected portions of said foreign and host virtual spaces as accessible only in an emulated supervisor mode, said detecting means coupled to said support software layer.

30. The system of claim 28 further comprising a page lock flag, said page lock flag indicating restricted access to selected portions of said foreign virtual space.

31. The system of claim 30 further comprising means for detecting the state of said page lock flag.

32. The system of claim 28 further comprising a common structure supported in hardware for maintaining said the foreign and host virtual spaces.

33. The system of claim 28 further comprising an access watch engine for detecting write accesses to said physical memory.

34. The system of claim 28 further comprising an emulated target supervisor flag for initiating binary translation from said foreign binary code to said host binary code.
